(19) United States
(12) Patent Application Publication
(10) Pub. No.: US 2026/0192675 A1
(43) Pub. Date: Jul. 9, 2026

(54) MITIGATION OF THE EFFECTS OF MOTOR CONTROLLER MALFUNCTIONS FOR VEHICLES WITH AN ELECTRIFIED POWERTRAIN

(71) Applicant: FCA US LLC, Auburn Hills, MI (US)

(72) Inventors: Xin Diao, Auburn Hills, MI (US); Shichao Huo, Auburn Hills, MI (US); Eric Blash, Auburn Hills, MI (US); Marryeh Chehrehsaztehrani, Auburn Hills, MI (US); Richard Roy, Auburn Hills, MI (US); Sampath Mandala, Auburn Hills, MI (US)

(21) Appl. No.: 19/014,317

(22) Filed: Jan. 9, 2025

(51) Int. Cl. B60L 3/00; B60L 58/13

(52) U.S. Cl. CPC B60L 3/0084; B60L 58/13; B60L 2240/12; B60L 2240/30; B60L 2240/42; B60L 2240/44; B60L 2240/48; B60L 2240/54; B60L 2250/10; B60L 2260/22

(57) ABSTRACT

An electronic securement system for an electrified vehicle includes a shifter device configured to control a park/reverse/neutral/drive (PRDN) state of a split power hybrid transmission and a control system configured to detect a neutral vehicle movement management (NVMM) state of the electrified vehicle where the PRND state of the split power hybrid transmission is neutral and that a speed of the electrified vehicle is less than a speed threshold indicative of a stopped vehicle and, in response to detecting the NVMM state, command a first electric motor of the split power hybrid transmission on via six switch open (6SO) operation, when the engine is on, command a second electric motor of the split power hybrid transmission to turn the engine off and, after the engine is off, command the second electric motor off via 6SO operation.

### FIELD

The present application generally relates to vehicle securement and, more particularly, to mitigation of the effects of motor controller malfunctions for vehicles with an electrified powertrain.

### BACKGROUND

In electrified vehicles having an electrified powertrain with an engine and a power split hybrid transmission, there is the possibility for unintended vehicle movement in a neutral gear/state because an output shaft of the transmission is always connected to the driveline (i.e., there is no disconnect clutch therebetween to physically decouple the respective shafts). Movement is typically prevented in the neutral gear/state by having the two electric motors of the transmission cancel each other's torque such that zero net torque is present at the transmission output shaft. However, during motor controller malfunctions, there could be instances where there is some positive/negative torque at the transmission output shaft, which could cause the electrified vehicle to move unintentionally in the neutral gear/state. Accordingly, while such conventional electrified vehicle securement techniques do work for their intended purpose, there exists an opportunity for improvement in the relevant art.

### SUMMARY

According to one example aspect of the invention, an electronic securement system for an electrified vehicle having an engine and a split power hybrid transmission including two electric motors is presented. In one exemplary implementation, the electronic securement system comprises a shifter device configured to control a park/reverse/neutral/drive (PRDN) state of the split power hybrid transmission and a control system configured to detect a neutral vehicle movement management (NVMM) state of the electrified vehicle where the PRND state of the split power hybrid transmission is neutral and that a speed of the electrified vehicle is less than a speed threshold indicative of a stopped vehicle and, in response to detecting the NVMM state, command a first electric motor of the split power hybrid transmission on via six switch open (6SO) operation, when the engine is on, command a second electric motor of the split power hybrid transmission to turn the engine off, where the second electric motor is configured for stop/start control of the engine, and, after the engine is off, command the second electric motor off via 6SO operation.

In some implementations, the electronic securement system further comprises an electric parking brake (EPB) configured to engage/disengage to selectively prevent movement of a driveline of the electrified vehicle, wherein the control system is further configured to determine whether a state of charge (SOC) of a high voltage battery system of the electrified vehicle is less than a first SOC threshold, wherein the high voltage battery system is configured to power the first and second electric motors and, when the SOC is less than the first SOC threshold, command the EPB to engage.

In some implementations, upon engagement of the EPB, the control system is further configured to command the first and second electric motors on, command the engine on using the second electric motor, and control recharging of the high voltage battery system via the engine and the second electric motor. In some implementations, the control system is further configured to command the first and second electric motors to perform auto-stop of the engine once the SOC of the high voltage battery system exceeds a second SOC threshold that is greater than the first SOC threshold.

In some implementations, after an auto-stop of the engine, the control system is further configured to command both the first and second electric motors off via 6SO operation. In some implementations, upon a manual customer disengagement of the EPB, the control system is further configured to command the first electric motor off via 6SO operation, command the engine off using the second electric motor, and command the second electric motor off via 6SO operation.

In some implementations, the control system is further configured to determine whether the SOC of the high voltage battery system is less than the first SOC threshold and when the SOC is less than the first SOC threshold, command the EPB to reengage and output, N times, a customer instruction or message indicating that the high voltage battery system needs to be recharged by the engagement of the EPB, where N is an integer greater than zero.

In some implementations, in response to another manual customer disengagement of the EPB after outputting the customer instruction or message N times, the control system is further configured to keep the engine off and continue outputting the customer instruction or message. In some implementations, the customer instruction or message comprises at least one of an audio, visual, and haptic output via the electrified vehicle.

According to another example aspect of the invention, an electronic securement method for an electrified vehicle having an engine and a split power hybrid transmission including two electric motors is presented. In one exemplary implementation, the electronic securement method comprises providing a shifter device of the electrified vehicle, the shifter device being configured to control a PRDN state of the split power hybrid transmission, detecting, by a control system of the electrified vehicle, a NVMM state of the electrified vehicle where a PRND state of the split power hybrid transmission is neutral and that a speed of the electrified vehicle is less than a speed threshold indicative of a stopped vehicle, and, in response to detecting the NVMM state, command a first electric motor of the split power hybrid transmission on via 6SO operation, when the engine is on, command a second electric motor of the split power hybrid transmission to turn the engine off, where the second electric motor is configured for stop/start control of the engine, and, after the engine is off, command the second electric motor off via 6SO operation.

In some implementations, the electronic securement method further comprises providing an EPB configured to engage/disengage to selectively prevent movement of a driveline of the electrified vehicle, determining, by the control system, whether an SOC of a high voltage battery system of the electrified vehicle is less than a first SOC threshold, wherein the high voltage battery system is configured to power the first and second electric motors, and when the SOC is less than the first SOC threshold, commanding, by the control system, the EPB to engage.

In some implementations, the electronic securement method further comprises upon engagement of the EPB, commanding, by the control system, the first and second electric motors on, commanding, by the control system, the engine on using the second electric motor, and controlling, by the control system, recharging of the high voltage battery system via the engine and the second electric motor. In some implementations, the electronic securement method further comprises commanding, by the control system, the first and second electric motors to perform auto-stop of the engine once the SOC of the high voltage battery system exceeds a second SOC threshold that is greater than the first SOC threshold.

In some implementations, the electronic securement method further comprises after an auto-stop of the engine, commanding, by the control system, both the first and second electric motors off via 6SO operation. In some implementations, the electronic securement method further comprises, upon a manual customer disengagement of the EPB, commanding, by the control system, the first electric motor off via 6SO operation, commanding, by the control system, the engine off using the second electric motor, and commanding, by the control system, the second electric motor off via 6SO operation.

In some implementations, the electronic securement method further comprises determining, by the control system, whether the SOC of the high voltage battery system is less than the first SOC threshold and, when the SOC is less than the first SOC threshold, commanding, by the control system, the EPB to reengage and outputting, N times by the control system, a customer instruction or message indicating that the high voltage battery system needs to be recharged by the engagement of the EPB, where N is an integer greater than zero.

In some implementations, the electronic securement method further comprises in response to another manual customer disengagement of the EPB after outputting the customer instruction or message N times, keeping, by the control system, the engine off and continuing outputting, by the control system, the customer instruction or message. In some implementations, the customer instruction or message comprises at least one of an audio, visual, and haptic output via the electrified vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a power split hybrid transmission and example electronic securement system according to the principles of the present application;

FIG. 2 is a functional block diagram of an example system architecture for the electronic securement system according to the principles of the present application; and

FIGS. 3A-3C are flow diagrams of an example electronic securement methods for an electrified vehicle having a power split hybrid transmission according to the principles of the present application.

### DESCRIPTION

As previously discussed, in electrified vehicles having an electrified powertrain with an engine and a power split hybrid transmission, there is the possibility for unintended vehicle movement in a neutral gear/state because an output shaft of the transmission is always connected to the driveline (i.e., there is no disconnect clutch therebetween to physically decouple the respective shafts). Movement is typically prevented in the neutral gear/state by having the two electric motors of the transmission cancel each other's torque such that zero net torque is present at the transmission output shaft. However, during motor controller malfunctions (memory corruptions, processing errors, etc.), there could be instances where there is some positive/negative torque at the transmission output shaft, which could cause the electrified vehicle to move unintentionally in the neutral gear/state, either on a graded or a flat surface. Conventional solutions to this problem involve fully disabling or deactivating the electrified powertrain or activating a securement system, such as forcing the transmission to transition to a park gear/state, but such solutions suffer from customer dissatisfaction.

Accordingly, improved electronic securement systems and methods for electrified vehicles having power split hybrid transmissions are presented herein. These electronic securement techniques perform neutral vehicle movement management (NVMM), which includes three possible phases depending on the high voltage battery system's state of charge (SOC). In a first state (also referred to herein as a “phase” or a “mode), NVMM is activated when a neutral state is requested (via a shifter) and the vehicle speed is below a threshold. When the engine is on, one motor (Motor B) is turned off via commanding a six switch open (6SO) state of the respective inverter. The engine is then controlled off using the other motor (Motor A), and thereafter Motor A is turned off via commanding the 6SO inverter state. When the engine is already off, both Motors A and B are turned off via commanding the 6SO inverter state. In a second state, the high voltage battery system's SOC could eventually drop below a threshold due to other power consumers (lights, displays, HVAC, etc.).

In this second state, an electronic parking brake (EPB) is engaged and both Motors A and B are turned on and the engine is started using Motor A. Thereafter, the engine and Motor A recharge the high voltage battery system until another higher threshold is reached, after which the system can revert to the off state (see the first state above). In a third state, the driver could manually disengage the EPB, and the system could transition back to the first state for at least a period. The EPB, however, could be reapplied (the second state) if the high voltage battery system's SOC remains too low. The third state could also involve providing an instruction to the customer/driver (audio, visual, haptic, or some combination thereof) to reengage the EPB (e.g., after manual disengagement) to for recharging of the high voltage battery system. Potential benefits of these improved electronic securement systems and methods of the present application include the ability to secure the electrified vehicle during motor controller malfunctions while also allowing for charging of the high voltage battery system such that the customer is not stranded.

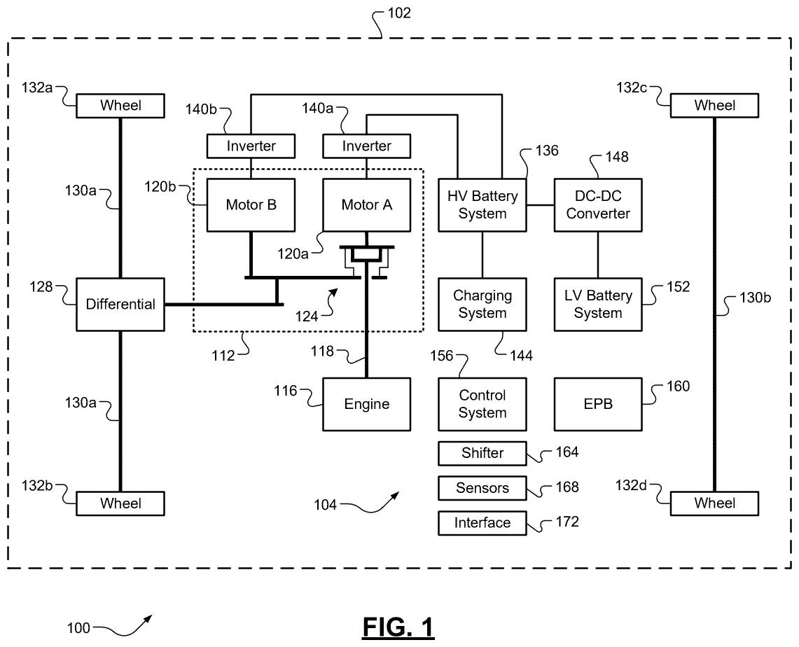

Referring now to FIG. 1, a functional block diagram of an electrified vehicle 100 having a power split hybrid transmission 112 and an example electronic securement system 104 according to the principles of the present application is illustrated. The electrified vehicle 100 generally comprises an electrified powertrain 102 that includes the split power hybrid transmission 112 and an internal combustion engine 116. The engine 116 is configured to combust a mixture of air and fuel (gasoline, diesel, etc.) to generate torque. The split power hybrid transmission 112 generally comprises first and second electric motors 120a, 120b (also “Motor A” and “Motor B,” respectively, and collectively “electric motors 120”) and a system of shafts/clutches 124 for controlling the power through the transmission 112 and via a differential 128 to axles or half-shafts 130 and to front wheels 132a, 132b. Motor A 120a can also be configured to control stop/start of the engine 116 (e.g., via a crankshaft or engine output shaft 118). The electric motors 120 are powered by a high voltage battery system 136 via electrical energy provided via respective inverters 140a, 140b. Each of the inverters 140a, 140b can have a three half bridge configuration with six switches (e.g., insulated gate bipolar junction transistors, or IGBTs) configured to generate three phase voltage control signals (e.g., pulse-width modulated, or PWM signals) to windings (not shown) of the respective electric motors 120.

Each of the inverters 140a, 140b is therefore capable of operating in a six-switch open or “6SO” mode (also known as a total phase interruption) where all of the inverter's switches are opened to thereby stop the flow of electrical energy to the respective electric motor 120, thereby allowing the electric motor 120 to freely spin (unless connected to another friction force). The electrified powertrain 102 further comprises a charging system 144 for external recharging of the high voltage battery system 136 and a DC-DC converter 148 for stepping down a high voltage bus, such as for supporting a low voltage (e.g., 12V) battery system 152. The electrified powertrain 102 is controlled by a controller or control system 156, which is also configured to control an electronic or electric parking brake (EPB) 160 that is configured to brake and stop the vehicle's driveline (e.g., at a rear axle 130b and rear wheels 132c, 132d). The electrified vehicle 100 also includes a shifter device 164 (e.g., for providing a driver-selection of park/neutral/drive/reverse, or PRND) and sensors 168 (e.g., for measuring electrical parameters in order to determine the SOC of the high voltage battery system 136). Lastly, the electrified vehicle 100 can further include a driver interface 172 for receiving other driver inputs (e.g., acceleration/braking/steering) and outputting instructions/messages to the driver (e.g., audio, visual, haptic, or some combination thereof).

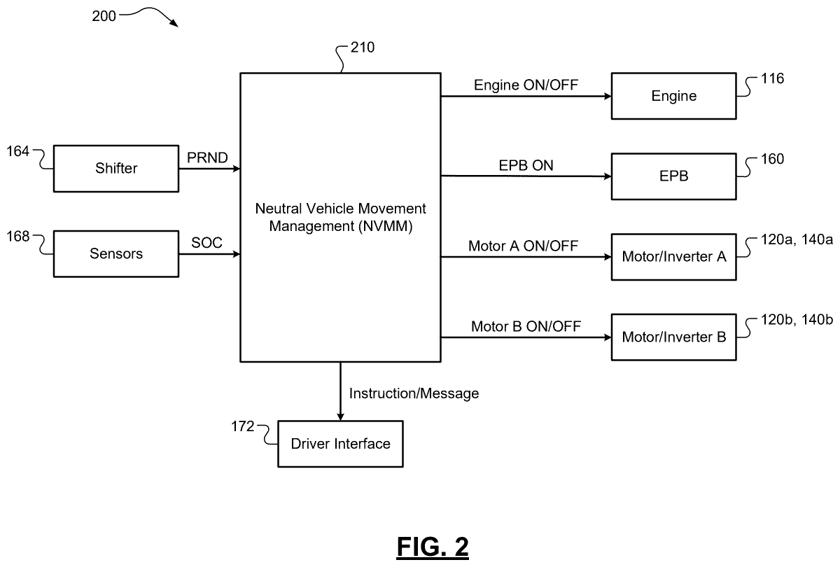

Referring now to FIG. 2 and with continued reference to FIG. 1, a functional block diagram of an example system architecture 200 for the electronic securement system 104 according to the principles of the present application is illustrated. This system architecture 200 primarily includes a NVMM block 210, which could represent software executable by the control system 156 of the electrified vehicle 100. As shown, the NVMM block 210 is configured to receive as inputs the PRND state from the shifter 164 and the high voltage battery system SOC (or other electrical parameters indicative of the SOC) from the sensors 168 and generate as outputs an ON/OFF control signal for the engine 116, an ON/enable/actuation signal for the EPB 160, as well as ON/OFF control signal for the electric motors 120a and 120b (which could include control signals to command their respective inverters 140a and 140b to transition into or out of the 6SO mode) and, in some cases, an instruction/message to the driver via the driver interface 172. As briefly discussed above, the electronic securement techniques of the present application can be generally divided into three distinct states, which will now be discussed in even greater detail below.

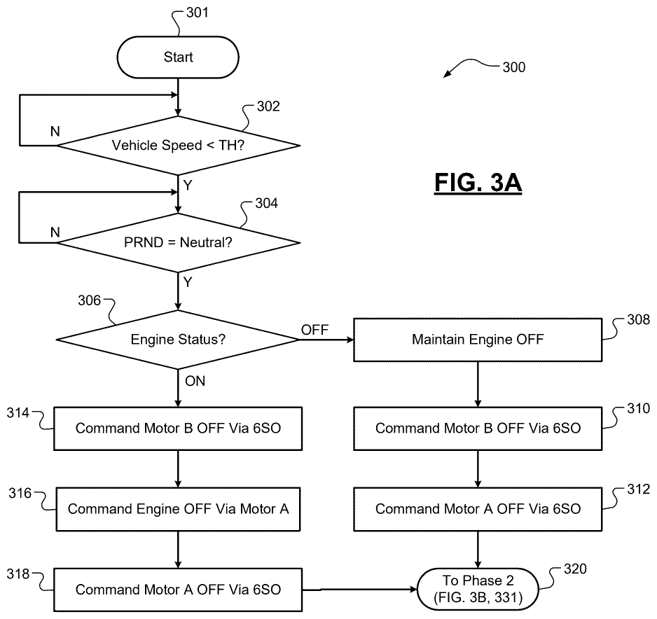

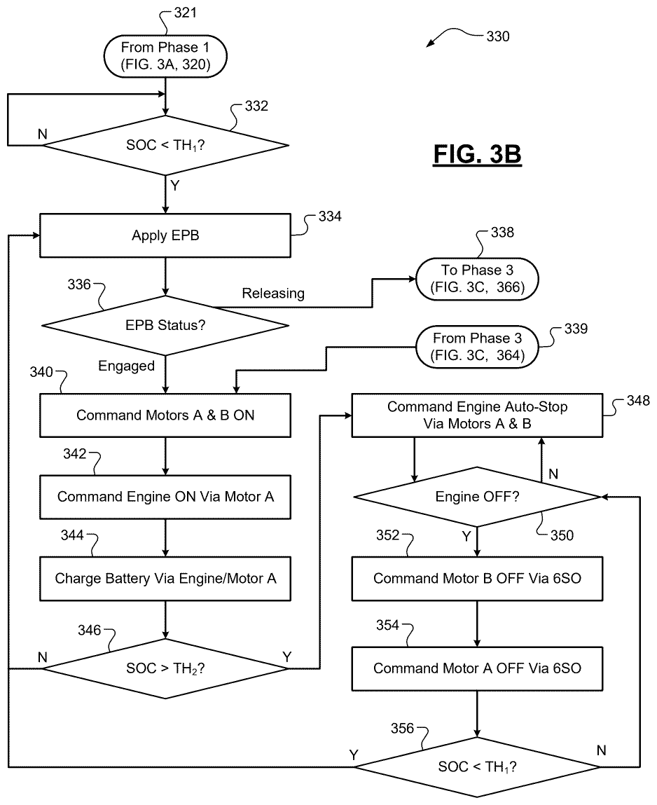

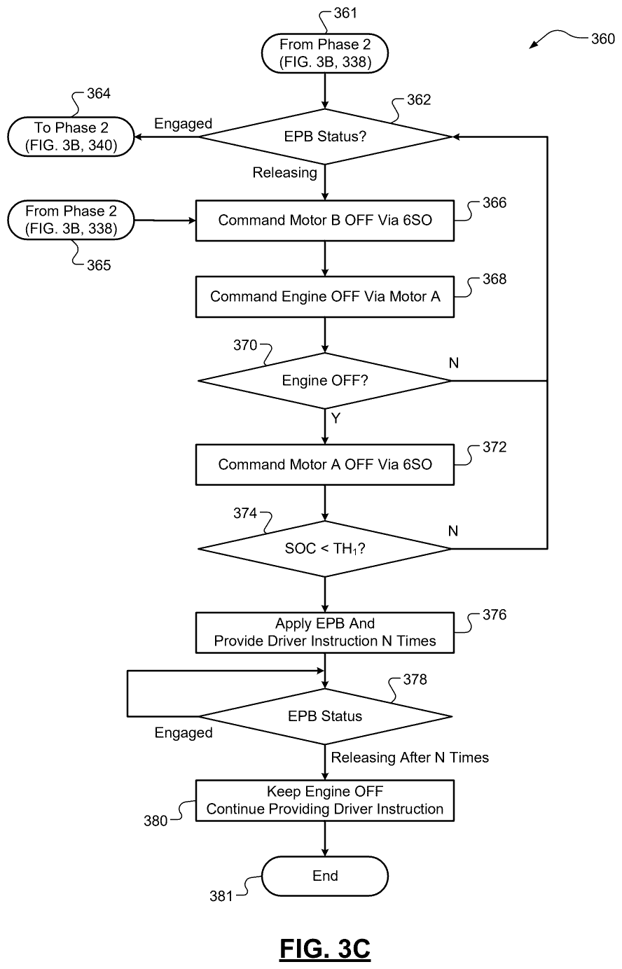

Referring now to FIGS. 3A-3C and with continued reference to the previous figures, flow diagrams of example electronic securement methods 300, 330, 360 for an electrified vehicle having a power split hybrid transmission according to the principles of the present application are illustrated. While these methods 300, 330, and 360 each reference the electrified vehicle 100 and its components for descriptive/illustrative purposes, it will be appreciated that the methods 300, 330, and 360 could be applicable to any suitably configured electrified vehicle having power split hybrid transmission.

Referring now to FIG. 3A, a first electronic securement method 300 (also referred to as the first state or Phase 1) begins at 301. At 302, the control system 156 determines whether the vehicle speed (e.g., measured by the sensors 168) is less than a vehicle speed threshold (TH), which is approximately zero to be indicative of a stopped vehicle. When false, the method 300 returns to 302. When true, the method 300 proceeds to 304. At 304, the control system 156 determines whether the PRND status (e.g., from the shifter 156) is neutral (N). When false, the method 300 returns to 302 or 304. When true, the method 300 proceeds to 306 as the vehicle 100 is intended to be stopped and in neutral. At 306, the control system 156 determines whether the engine 116 is ON or OFF. When OFF, the method 300 proceeds to 308. When ON, the method 300 proceeds to 314. At 308, the control system 156 commands Motor B 120b OFF via 6SO. At 312, the control system 156 commands Motor A 120a OFF via 6SO. The method 300 then proceeds to 320, which indicates a transition to the second state or phase (Phase 2) described below and shown in FIG. 3B. At 314, the control system 156 commands Motor B OFF via 6SO. At 316, the control system 156 commands the engine 116 OFF using Motor A (engine stop control). At 318, the control system 156 commands Motor A OFF via 6SO. Finally, the method 300 proceeds to 320

Referring now to FIG. 3B, a second electronic securement method 330 (second state or Phase 2) begins at 331. At 331, the control system 156 determines whether the SOC of the high voltage battery system 136 (or “battery system SOC”) is less than a first/low SOC threshold (TH₁). This first/low SOC threshold TH₁ represents an SOC level at which the high voltage battery system 136 needs to be recharged, such as to prevent potential overuse and potential damage thereto or to avoid stranding the customer. When false, the method 330 returns to 331. When true, the method 330 proceeds to 334. At 334, the control system 156 applies the EPB 160 to secure/stop the vehicle 100. At 336, the control system 156 determines or checks the status of the EPB 160. When the status is released or releasing, the method 300 proceeds to 338, which indicates a transition to the third state or phase (Phase 3) described below and shown in FIG. 3C. When the status is engaged, the method 330 proceeds to 340. As later discussed/shown, step 362 of Phase 3 (FIG. 3C) could also result in a transition to step 340 (shown here as 339). At 340, the control system 156 commands the electric motors 120 ON and then at 342 the control system 156 commands the engine 116 ON using Motor A 120a (engine start control).

At 344, the control system 156 controls recharging of the high voltage battery system 136 using the engine 116 and Motor A 120a. At 346, the control system 156 determines whether the battery system SOC is less than a second/high SOC threshold (TH₂). This second/high SOC threshold TH2 represents an SOC level at which the high voltage battery system 136 no longer needs to be recharged, such as to prevent overcharging and potential damage. When false, the method 330 returns to 334. When true, the method 330 proceeds to 348. At 348, the control system 156 commands engine auto-stop control via the electric motors 120. At 350, the control system 156 determines whether the engine 116 is OFF. When false, the method 330 returns to 348. When true, the method 330 proceeds to 352. At 352, the control system 156 commands Motor B 120b OFF via 6SO. At 354, the control system 156 commands Motor A 120a OFF via 6SO. At 356, the control system 156 determines whether the battery system SOC is less than the first/low SOC threshold TH₁. When false, the method 330 returns to 350. When true, the method 330 returns to 334.

Referring now to FIG. 3C, a third electronic securement method 360 (third state or Phase 3) begins at 361. At 362, the control system 156 determines the states of the EPB 160. This step 362 is technically the same as step 336 of Phase 2 (FIG. 3B) but is reproduced here as well. When engaged, the method 360 proceeds to 364, which indicates a transition back to step 340 of the second state or phase (Phase 2) described above and shown in FIG. 3B. When releasing or released, the method 360 proceeds to 366. As previously discussed/shown, step 338 of Phase 2 (FIG. 3B) could also result in a transition to step 366 (shown here as 365). At 366, the control system 156 commands Motor B 120b OFF via 6SO. At 368, the control system 156 commands the engine 116 OFF using Motor A 120a. At 370, the control system 156 verifies whether the engine 116 is OFF. When false, the method 360 returns to 362. When true, the method 360 proceeds to 372. At 372, the control system 156 commands Motor A 120a OFF via 6SO. At 374, the control system 156 determines whether the battery system SOC is less than the first/low SOC threshold TH₁. When false, the method 360 returns to 362. When true, the method 360 proceeds to 376. At 376, the control system 156 applies (or reapplies, such as after manual customer disengagement) the EPB 160 and provides a driver instruction/message (e.g., via the driver interface 172) a calibratable N times (N being an integer greater than zero). At 378, the control system 156 determines the status of the EPB 160. For example, the customer could have manually disengaged the EPB 160. When engaged, the method 360 remains at 378. When releasing or released after the N instructions/messages, the method 360 proceeds to 380. At 380, the control system 156 keeps the engine 116 OFF and continues providing the driver instruction/message and the method 300 then ends at 381.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An electronic securement system for an electrified vehicle having an engine and a split power hybrid transmission including two electric motors, the electronic securement system comprising:
a shifter device configured to control a park/reverse/neutral/drive (PRDN) state of the split power hybrid transmission; and
a control system configured to:
detect a neutral vehicle movement management (NVMM) state of the electrified vehicle where the PRND state of the split power hybrid transmission is neutral and that a speed of the electrified vehicle is less than a speed threshold indicative of a stopped vehicle; and
in response to detecting the NVMM state:
command a first electric motor of the split power hybrid transmission on via six switch open (6SO) operation;
when the engine is on, command a second electric motor of the split power hybrid transmission to turn the engine off, where the second electric motor is configured for stop/start control of the engine; and
after the engine is off, command the second electric motor off via 6SO operation.

2. The electronic securement system of claim 1, further comprising an electric parking brake (EPB) configured to engage/disengage to selectively prevent movement of a driveline of the electrified vehicle, wherein the control system is further configured to:
determine whether a state of charge (SOC) of a high voltage battery system of the electrified vehicle is less than a first SOC threshold, wherein the high voltage battery system is configured to power the first and second electric motors; and
when the SOC is less than the first SOC threshold, command the EPB to engage.

3. The electronic securement system of claim 2, wherein upon engagement of the EPB, the control system is further configured to:
command the first and second electric motors on;
command the engine on using the second electric motor; and
control recharging of the high voltage battery system via the engine and the second electric motor.

4. The electronic securement system of claim 3, wherein the control system is further configured to command the first and second electric motors to perform auto-stop of the engine once the SOC of the high voltage battery system exceeds a second SOC threshold that is greater than the first SOC threshold.

5. The electronic securement system of claim 4, wherein after an auto-stop of the engine, the control system is further configured to command both the first and second electric motors off via 6SO operation.

6. The electronic securement system of claim 2, wherein upon a manual customer disengagement of the EPB, the control system is further configured to:
command the first electric motor off via 6SO operation;
command the engine off using the second electric motor; and
command the second electric motor off via 6SO operation.

7. The electronic securement system of claim 6, wherein the control system is further configured to:
determine whether the SOC of the high voltage battery system is less than the first SOC threshold; and
when the SOC is less than the first SOC threshold:
command the EPB to reengage; and
output, N times, a customer instruction or message indicating that the high voltage battery system needs to be recharged by the engagement of the EPB, where N is an integer greater than zero.

8. The electronic securement system of claim 7, wherein in response to another manual customer disengagement of the EPB after outputting the customer instruction or message N times, the control system is further configured to keep the engine off and continue outputting the customer instruction or message.

9. The electronic securement system of claim 8, wherein the customer instruction or message comprises at least one of an audio, visual, and haptic output via the electrified vehicle.

10. An electronic securement method for an electrified vehicle having an engine and a split power hybrid transmission including two electric motors, the electronic securement method comprising:
providing a shifter device of the electrified vehicle, the shifter device being configured to control a park/reverse/neutral/drive (PRDN) state of the split power hybrid transmission;
detecting, by a control system of the electrified vehicle, a neutral vehicle movement management (NVMM) state of the electrified vehicle where a PRND state of the split power hybrid transmission is neutral and that a speed of the electrified vehicle is less than a speed threshold indicative of a stopped vehicle; and
in response to detecting the NVMM state:
command a first electric motor of the split power hybrid transmission on via six switch open (6SO) operation;
when the engine is on, command a second electric motor of the split power hybrid transmission to turn the engine off, where the second electric motor is configured for stop/start control of the engine; and
after the engine is off, command the second electric motor off via 6SO operation.

11. The electronic securement method of claim 10, further comprising:
providing an electric parking brake (EPB) configured to engage/disengage to selectively prevent movement of a driveline of the electrified vehicle;
determining, by the control system, whether a state of charge (SOC) of a high voltage battery system of the electrified vehicle is less than a first SOC threshold, wherein the high voltage battery system is configured to power the first and second electric motors; and
when the SOC is less than the first SOC threshold, commanding, by the control system, the EPB to engage.

12. The electronic securement method of claim 11, further comprising, upon engagement of the EPB:
commanding, by the control system, the first and second electric motors on;
commanding, by the control system, the engine on using the second electric motor; and
controlling, by the control system, recharging of the high voltage battery system via the engine and the second electric motor.

13. The electronic securement method of claim 12, further comprising commanding, by the control system, the first and second electric motors to perform auto-stop of the engine once the SOC of the high voltage battery system exceeds a second SOC threshold that is greater than the first SOC threshold.

14. The electronic securement method of claim 13, further comprising after an auto-stop of the engine, commanding, by the control system, both the first and second electric motors off via 6SO operation.

15. The electronic securement method of claim 11, further comprising upon a manual customer disengagement of the EPB:
commanding, by the control system, the first electric motor off via 6SO operation;
commanding, by the control system, the engine off using the second electric motor; and
commanding, by the control system, the second electric motor off via 6SO operation.

16. The electronic securement method of claim 16, further comprising:
determining, by the control system, whether the SOC of the high voltage battery system is less than the first SOC threshold; and
when the SOC is less than the first SOC threshold:
commanding, by the control system, the EPB to reengage; and
outputting, N times by the control system, a customer instruction or message indicating that the high voltage battery system needs to be recharged by the engagement of the EPB, where N is an integer greater than zero.

17. The electronic securement method of claim 16, further comprising in response to another manual customer disengagement of the EPB after outputting the customer instruction or message N times, keeping, by the control system, the engine off and continuing outputting, by the control system, the customer instruction or message.

18. The electronic securement method of claim 17, wherein the customer instruction or message comprises at least one of an audio, visual, and haptic output via the electrified vehicle.
